(19) United States
(12) Patent Application Publication
(10) Pub. No.: US 2005/0216285 A1
(43) Pub. Date: Sep. 29, 2005

(54) Flavor selection and optimization process

(76) Inventors: Carlos Jose Barroso, Dallas, TX (US); Eapen George, Frisco, TX (US)

Correspondence Address: Colin P. Cahoon;Carstens Yee & Cahoon, L.L.P., P.O. Box 802334, Dallas, TX, 75380, US

(21) Appl. No.: 10/811,003

(22) Filed: Mar. 26, 2004

(51) Int. Cl. A23L 1/22

(52) U.S. Cl. 705/1

(57) ABSTRACT

A method for selecting flavors and aromas for snack foods in order to sustain long-term product sales to target demographics. The method involves identifying flavor and related aroma drivers that elicit an emotional response from the targeted demographic group by consumer testing. The flavor drivers are then incorporated into the food product by, for example, coating the product with a flavored oil.

### BACKGROUND OF THE INVENTION

1. Technical Field

The present invention relates to a method of selecting flavors and aromas for snack foods in order to sustain long-term product sales to target demographics. The method identifies flavor and related aroma drivers specific to the target demographics and tests these flavors to obtain an emotional response tailored for the specific demographics. Once the flavor has been identified to produce the selected emotional response, this flavor is added, generally by flavored oils, to a specific food product that is marketed to the target demographics.

2. Description of Related Art

Flavor is one of the main sensory properties that is decisive in the selection, acceptance and ingestion of food. Specific aromas, fragrances and formulations are commonly designed and implemented in various foods and perfumes. A food flavor is derived from both the taste and aroma or smell of a food. Typically a skilled flavorist, chemist, perfumist or fragrance formulator will experiment with various oils, extracts, and synthetic materials to achieve a desired flavor, aroma, or fragrance.

U.S. Pat. No. 4,640,842, a patent for an internally flavored hull cereal grain, discloses that those skilled in the art can use available reference books that compile suggested acceptable use levels for flavorants in foodstuffs. Similarly, U.S. Pat. No. 5,942,272, a patent for an odorant composition, also discloses a reference book that contains a broad range of known odorants or odorant mixtures that can be used by a skilled perfumer. With the aid of such references, flavorists and perfumists alike use their creative abilities to develop flavors and aromas that consumers will hopefully demand.

Unfortunately, a flavorist or perfumist can only formulate a product or additive based upon his or her best guess of what a consumer desires. This is undesirable because product development, manufacture and marketing are very expensive and new product flavors require a substantial investment. Consequently, there is a need for a method to determine which flavors, derived from taste and smell, will consistently, and over the long term, appeal to a consumer before a product is launched.

One prior art solution to ensuring success in a new product flavor is to have a test group of consumers rate the taste of the food product on a scale of 1 to 10, and a taste that reaches a certain threshold on this scale is then marketed on a wide-scale. Unfortunately, this top-down approach of the food product manufacturer determining the taste and imposing the taste on national or world wide levels based upon the taste rating of a select group of consumers does not provide a means to ascertain product sustainability in various markets where tastes and response may be different. Further, testing only for taste measures only an initial consumer response, as opposed to measuring the consumer's propensity for purchasing said product in the future. The correlation between taste and sustainable sales is not necessarily directly related. There is no guarantee the best tasting product will be the best selling product over time.

Another prior art solution to ascertaining sustainability of a new product is to test market that product. For example, rather than having a nationwide rollout of a new product, a particular city or geographical location is targeted and sales of the product in that area are monitored. However, this prior art solution also has several drawbacks because it may fail to accurately measure product sustainability for a number of reasons. First, the newness of a flavor will likely attract a number of first time purchasers who buy the product simply to try it out. They may buy additional product so their friends or family can try the new product as well. Thus, it is difficult to ascertain whether the product is being purchased because it is new or because the consumer has tried the product and desires additional product. Second, different consumers may first encounter the new product at different times. Thus, after two or three months of sales, it is difficult to know whether the sales of the new product are repeat sales or first time sales. Moreover, people may initially make repeated purchases of the product merely because it is new and different. They may then tire of the product, despite initially finding the taste to be quite pleasing. Thus, a long period of time is required for the test market to elicit reliable information about product sustainability. Third, flavors that do well in certain geographical locations may not do well in other locations and vice versa. Thus, the confidence level for the reliability of a single test market is low. Unfortunately, the purpose of a test market is to provide reliable data. Geographical preference differences may be especially disparate not only between regions of the world but regions within a country. As a result, a product that does well in one part of the country may not be sustainable in other parts of the country. Likewise, a product popular in one part of the world, for example Central America, may not be popular in the United States. Thus, multiple test markets may be required to ensure confidence in the results, resulting in increased costs. Fourth, in the event the test market is unsuccessful, large sums of money spent for product development and marketing in that test market are still lost. Even when a product shows initial promise, there is often a dramatic fall off in product sales after the product's first year in the market. This demonstrates that taste alone is an insufficient predictor of product sustainability. Consequently, there is a need for a method to determine which flavors will consistently appeal to a consumer and provide product sustainability.

It is well known that taste does not elicit the same power for memory recollection as smell. People, upon smelling a familiar aroma, often link the aroma to a memory. For example, a certain brand of cologne or perfume may remind one person of another person that used to wear the cologne or perfume. A unique odor may evoke a memory of an event long past or a specific location once visited. This is because the olfactory nerve, an extension of the brain, comprises olfactory epithelium with some 20 million-nerve endings. These epithelium, located in the roof of the two nasal cavities of the human nose just below and between the eyes, when exposed to an odor, transmit a nerve message to the part of the brain involved with memory, emotions, and learning. Thus, aromas and fragrances that irritate, please, or trigger a memory can evoke an emotional response. This emotional response can be detected by monitoring brain activity. Perfume and fragrance makers have tried to exploit the link, or association that people have to a particular smell. For example, U.S. Pat. No. 6,298,263, a patent for a method for odor selection, discloses measuring brain activity to provide an objective measure of the degree of implicit association between an odor, such as the smell of a rose, and a target, such as a rose. Similarly, U.S. Pat. No. 6,463,786 is also directed to a testing method for providing an objective measure of the degree of implicit association between an odor and a target. However, neither of these patents disclose a method to enable one to determine a way to identify a target that will elicit a positive emotional response from different people within a demographic group to achieve sustainability of a new food product line.

Accordingly, a need exists for a method of identifying flavors and/or aromas that generate a reaction in a target demographic that supports product sustainability over a long period of time. Such method should be adaptable to a variety of demographics, thereby potentially producing different product formulations depending on the demographics targeted.

### SUMMARY OF THE INVENTION

The present invention is directed toward a method of selecting a flavor for a food product in order to sustain long-term product sales to target demographics. The method identifies a demographic group and flavor drivers with an odor or taste that evokes a desired product concept from the demographic group. The identified flavor drivers are then tested by consumers within the demographic group to determine or confirm that the flavor drivers in the food product produce the desired product concept. The flavor drivers are then applied, generally by flavored oils, to a specific food product that is marketed to the demographic group.

The consumer testing comprises members of the demographic group smelling and tasting the food product, comparing the consumer's reaction to the food qualities on a concept board, indicating any emotional response the flavor elicits, and rating the product in light of the concepts presented.

### BRIEF DESCRIPTION OF THE DRAWINGS

The novel features believed characteristic of the invention are set forth in the appended claims. The invention itself, however, as well as preferred modes of use, further objectives, and advantages thereof, will be best understood by reference to the following detailed description of illustrative embodiments when read in conjunction with the accompanying drawings, wherein:

FIG. 1 is a flow chart of one embodiment of the invention;

FIG. 2 is a concept board of one embodiment of the invention;

FIG. 3 is a flow chart of consumer testing steps of one embodiment of the invention.

### DETAILED DESCRIPTION

Unlike the prior art top-down method, where flavors are initially chosen by those skilled in the art and added to foods and where the potential sustainability of the foods is based on consumer tests or market tests, the present invention is directed towards a bottom-up method of making a flavor based on a specific demographic group to sustain long-term product sales to the targeted demographic group. This is achieved in the following way.

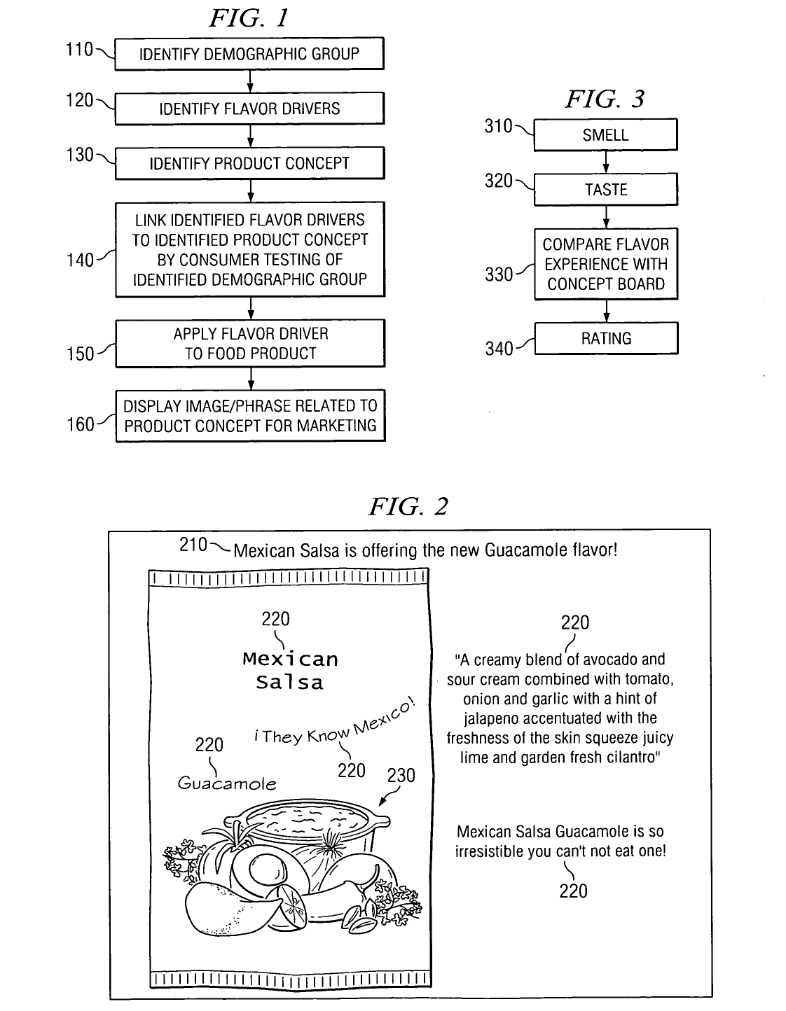

FIG. 1 is a flow chart illustrating the overall steps of one embodiment of Applicant's invention. Accordingly, first, a demographic group is identified 110. As used herein, a demographic group is defined as a population set in a geographical region that shares at least one statistical characteristic. The shared statistical characteristic could be nearly any characteristic including, but not limited to, age, race, sex, personal income, net worth, marital status, or educational attainment. As used herein, a geographical region is defined as an area where people with a shared statistical characteristic identify with a certain cultural identity. For example, young adults aged 18-34 that live in Great Britain and young adults aged 18-34 in Mexico do not share the same cultural identity. Thus, foods desired by 18-34 year olds in Great Britain are not likely the same foods desired by 18-34 year olds in Mexico. But, young adults aged 18-34 that reside in Mexico could comprise a demographic group, as would young adults aged 18-34 in Great Britain. However, it should be noted that cultural identities may extend beyond or be contained within political borders. For example, the United States may comprise several geographical regions including, but not limited to the South, the Northeast, the Midwest, or the Northwest. There may even be subsets of geographical regions within the geographic regions. For example, Southern Louisiana is famous and known for its Cajun culture. Even within some cities, as evidenced by Chinatown in San Francisco, there are geographical regions with a certain cultural identity.

Second, a plurality of flavor drivers familiar to the demographic group selected in the first step 110 are identified 120. As used herein, a flavor driver comprises a food additive, such as seasoning, that affects the taste and/or smell of a food product. In one embodiment, a flavor driver is comprised of a flavored oil. These flavor drivers can be based on reason to believe ingredients, which are ingredients frequently used for the preparation of traditional foods for that demographic group. As used herein, a reason to believe ingredient is a food ingredient familiar to the demographic group. Identifying flavor drivers, or reason to believe ingredients familiar to the demographic group can occur in any number of ways including, but not limited to, market research data concerning the foods consumed by the demographic group, surveying restaurants or chefs that work in restaurants that are frequented by the demographic group, surveying a representative sample of the demographic group, or based upon general knowledge of that demographic group. For example, master chefs that prepare foods in restaurants frequented by 18-34 year olds in Mexico can be consulted to elicit information concerning food flavorants frequently used for the preparation of traditional foods for that demographic group. The smell or aroma and taste of these flavorants can then be the basis for selected flavor drivers. These identified flavor drivers can then form the basis for ingredients in a food product.

Third, a desired product concept for the food product is identified 130. As defined herein, a desired product concept comprises an implicit or express desired emotional response. For example, a desired product concept for the food product may be freshness, authenticity, and/or home cooking. This product concept is illustrated visually on a concept board. A concept board comprises images, words, and/or phrases relating to the desired product concept. Using a concept board for concept testing is known in the art. An example of a concept board is shown in FIG. 2. Concept testing is a quantitative research tool that evaluates and diagnoses the performance of fully developed conceptual ideas, such as a product concept, created to meet consumer demand. In one embodiment, the concept board comprises a headline 210, one or more sub-headlines or phrases 220, and visual images 230. In one embodiment the desired product concept can be the headline. Or the headline can be a pronouncement. For example, the headline 210 can read “Mexican Salsa is offering the New Guacamole Flavor.” The sub-headline 220 can be either explicit or suggestive words or phrases related to the product concept such as “Mexican Salsa” or “They know Mexico!” Images 230 can be shown, for example, of food ingredients that depict the flavor of the product concept—in this case authentic Mexican Salsa. Although the above embodiment is one example that may be used as a product concept board, it should be recognized that this example is provided only for illustration and not limitation. For example, an image can depict a child in a house or a family opening Christmas presents near a stocking-laden fireplace adjacent to a Christmas tree. The product concept board can use any combination of images, words, or phrases in any order that the food product manufacturer feels conveys the desired product concept.

Returning to FIG. 1, the fourth step in the overall process comprises identifying, by way of special consumer testing within the desired demographic group, at least one flavor driver that supports the desired product concept 140. The instant invention focuses on the consumer's emotional response and identification with the product concept, as opposed to merely rating taste. In other words, a product is selected based upon the implicit or explicit affect of its flavor on the demographic group. As discussed previously, taste alone is an insufficient reason for consumers to buy a food product. A flavor, however, that comprises a familiar aroma, one that may remind the consumer about a favorable past memory or feeling, or triggers some other emotion or concept, will likely result in product sustainability. The main purpose of the consumer testing is to determine the combination of flavor drivers that most strongly elicit a link between the demographic group and a product concept. Thus, it is possible that the combination of flavor drivers that tastes the best is not the combination selected. This consumer testing will be explained in more detail below in reference to FIG. 3.

Finally, in a fifth step, once a flavor driver is identified as supporting a desired product concept, at least one flavor driver identified in the previous step is then applied to the food product 150. In one embodiment, a flavor driver is applied by spraying a flavored oil on the food product. In one embodiment, the food product comprises a snack food. As used herein a snack food is defined as a starch based substrate and includes tortilla chips and potato crisps. A flavored oil can, for example, be applied to a potato crisp or tortilla chip after the food substrate is cooked, but before the food substrate is seasoned. Flavored oils are known in the art. A list of some of the known flavored edible oils is presented, for example, in U.S. Pat. No. 6,444,253. The use of flavored oils is a preferred flavor delivery system because oils are far better at affecting the olfaction or sense of smell of a consumer. Use of flavored oils have the additional benefit of reducing production costs, because use of flavored oils, which are such strong purveyors of flavor, reduce the amount of seasoning required. Once the food product formulation for a demographic group is perfected, a food product manufacturer can focus on marketing to that demographic group.

Optionally, in a sixth step, the marketing of the food product to the target demographic group links the targeted group to the food product for that group 160. In one embodiment, the packaging of the food product can comprise images or phrases related to the desired concept and uses the same or similar images or phrases shown on the concept board. In one embodiment, the images or phrases comprise illustrations or descriptions of the reason to believe ingredients. This gives members of the target demographic group an expectation of the product before the product is tried. Likewise, advertising, including product packaging, can also trumpet the product concept theme or show illustrations and descriptions of reason to believe ingredients. Because the food product is tailor made for a demographic group, targeted marketing can efficiently exploit the link the demographic group has with the food product.

FIG. 3 is a flowchart of consumer testing steps of one embodiment of the invention. As shown in FIG. 3 a consumer is given an opportunity to smell 310 at least one food product having at least one flavor driver. The consumer can then ask if he or she can identify what he or she smelled.

Next, the consumer can taste 320 a food product having at least one flavor driver identified above. In one embodiment, the consumer rates the food product for qualities that are important to the demographic group. For example, the food product can be rated for individual properties including, but not limited to, naturalness, freshness, authenticity, spiciness, or for any other desired property.

The consumer can then be asked to compare 330 the flavor experience with words and images posted on a concept board. In one embodiment, a consumer samples a variety of flavors and compares each flavor experience with the words, images, or phrases on the concept board. The words and images for the concept board can be based on the product concept chosen by the food product manufacturer. The consumer is asked for each sample whether the flavor experience causes the consumer to think about something on the concept board. In one embodiment, the consumer is asked to supply words that he or she feels properly described the food product and/or memories or other emotional responses evoked by the food product flavor. In this embodiment, the consumer is asked to supply words or articulate feelings, thoughts, emotions, or memories evoked by the flavored food product. In one embodiment, a consumer testing a cilantro-flavored snack food chip is asked to compare the flavor to words, images, or phrases on a concept board pertaining to things such as Mexican, pico de gallo, guacamole, freshness, real, lime, cilantro, salsa, freshness, authentic, etc. In an alternative embodiment, the consumer is presented with a concept board with words or images such as kitchen, my grandmother, or a calming scene. In one embodiment, a consumer is asked indirect questions, that are used to assess the link the food product has to a product concept. Indirect questions include, but are not limited to, asking a consumer to rate the food product for freshness or authenticity. In one embodiment, a product concept is shown or described to the consumer before the consumer smells or tastes the product. Thus, while FIG. 3 depicts the steps in a sequential order, that specific sequential order need not be followed. The above embodiments are shown for illustration and not limitation.

Following the comparison of the flavor experience with the concept board, the consumer is then asked to rate 340 the food product for food product properties, including but not limited to, taste or preference with regard to other tested flavors or controlled flavors, the level of intensity the consumer's flavor experience matched one or more items on the concept board, or the level of nostalgia or emotion that the consumer felt while eating the food product. If consumer testing revealed that an 18-34 year old living in Mexico associates a cilantro flavor with a sense of freshness, then a cilantro flavor (taste and aroma) is identified as a flavor driver supporting the product concept of freshness. Thus, a match linking the flavor driver to the product concept is established. Moreover, the consumer testing may reveal the combination of the same or different intensities of cilantro and lime flavors evoke a stronger sense of freshness than a cilantro flavor alone. The match linking flavor drivers to the product concept can then be refined because it is possible that a combination of flavor drivers may best support a product concept. The above consumer testing steps are just one example of how at least one flavor driver may be identified as supporting a desired product concept. Consumer testing can also incorporate other methods known in the art, such as brain wave testing. It should be noted that using the consumer testing described above, the best tasting food product may not be the one selected. The objective of the consumer testing is not to find the best tasting food product but to find the food product that provides a link to a product concept or emotional response.

There are a number of advantages provided by the present invention. First, it provides a method that produces a powerful market appeal specific to a targeted market. Second, use of the invention results in a product with long term, product sales or sustainability in the market because of the emotional response link the targeted demographic has to the product. Third, the invention provides predictability of success of a new food product because the product has already been tested by members of the targeted demographic group. Fourth, use of the invention reduces costs associated with new product rollouts. Because of the product sustainability and predictability, sums of money spent on marketing the product will produce more return. Moreover, advertising and other marketing dollars are efficiently targeted to members of the targeted demographic group. Fifth, overall risk of losing money on new food products is lowered because of the conceptual link that exists with the targeted demographic of the product. Sixth, the invention provides a means for aiding a target demographic to identify a product they will likely enjoy.

The following is a specific example of one embodiment of the invention. As shown in FIG. 1, a demographic group was identified 110. Market research indicated that older Mexicans did not consume as much potato chip product as the younger generation because many of the older generation was less familiar with the foreign potato chip flavors. The demographic group comprised 25 and older males and females located in Mexico.

Second, a master chef in this region that was a known chef celebrity and had served recipes of traditional foods to the demographic group was contacted. The master chef was asked to provide information about flavorants used in foods popular to the demographic group. Thus, a set of reason to believe ingredients were identified that would cause a consumer of the targeted demographic to believe the food was familiar. The chef identified such flavorants, or reason to believe ingredients, as lime, cilantro, corriander leaves, tomatoes, avocado, sour cream, onion, and poblano and serrano chiles. From the reason to believe ingredients, flavored oil flavor drivers comprising lime and cilantro were selected 120. Other reason to believe ingredients were placed into a dry seasoning mix. The reason to believe ingredients selected for addition as flavored oils and/or as a dry seasoning mix, as well as the relative level of each ingredient was refined and optimized during consumer testing (discussed below).

Third, “Salsa Mexicana,” meaning authentic Mexican salsa, was identified as a desired product concept 130. The purpose of this product concept was to target the demographic group with the message that the ingredients were familiar and popular with that demographic group.

Fourth, consumers within the targeted demographic group were recruited to engage in product testing to optimize the use of the reason to believe ingredients. Consumer testing was done to authenticate and confirm the chef's assertion that the reason to believe ingredients connected with the demographic group 140. One function of a reason to believe ingredient is for a consumer in the identified demographic group, upon hearing or seeing that these flavors are in a food product, to have a reason to believe that he or she would have a connection with the product concept of authentic Mexican salsa. Consumer testing confirmed that the reason to believe ingredients, in this case lime, cilantro, onion, sour cream, and chile sent the message to the demographic group that the product was authentic Mexican salsa. Moreover, consumer testing strongly indicated that food product comprising flavored oil flavor drivers comprising lime and cilantro triggered greater recognition than the non-flavored oil food product.

Referring to FIGS. 2 and 3, the consumer testing took place in the following manner. FIG. 2 is a concept board similar to that used in consumer testing. Consumers comprising Mexicans older than 25 were selected and asked a series of questions about a test sample and a control sample. The test sample contained flavored oils and the control sample contained no flavored oils. FIG. 3 is a flow chart of consumer testing steps of one embodiment of the invention. Evaluation of the two samples included smelling the aroma 310 as the test consumer opened each sample bag, and selecting preference between the two samples. Consumers were asked to taste 320 the food product. One objective of the consumer testing was for consumers to compare the flavor experience of the food products to a concept board 330. Consumers were asked to read the following descriptive phrase 220 of the product as depicted on the product concept board: “A creamy blend of avocado and sour cream combined with tomato, onion and garlic with a hint of jalapeno accentuated with the freshness of the skin squeeze juicy lime and garden fresh cilantro.” After reading the phrase 220 and seeing the visual images 230, consumers were asked to evaluate a control sample and a test sample and compare the two samples with the description 220 and the visual images 230 on the concept board. Consumers rated the correlation of the flavor experience with the concept board 330. Consumers also rated the food product for overall acceptability, overall flavor, and for food properties determined by the chef to be important to the demographic group. Consumers confirmed food properties of naturalness, freshness, and authenticity that signaled authentic Mexican salsa were present in the test sample and indicated that lime and cilantro triggered recognition of naturalness, freshness, and authenticity of Mexican salsa.

Next, as indicated on FIG. 1, based on the results of the consumer testing discussed above, flavor drivers comprising flavored oils of lime and cilantro, available from International Flavors and Fragrances, located in Union Beach, New Jersey and a dry powder seasoning mix comprising the other flavors of avocado, sour cream, tomato, onion, garlic, and jalapeno, available from McCormick® of Sparks, Md., were applied to a snack food chip 150. The final snack food product elicits an authentic, fresh, natural Mexican taste from most Mexicans over the age of 25. Marketing was targeted to the target demographic group and consisted of showing the authentic Mexican flavors used as ingredient flavors 160 as well as an endorsement from a master chef in the region. For example, an illustration similar to the package shown in FIG. 2, depicting images of reason to believe ingredients, including, but not limited to, cilantro, lime, and guacamole were used on the product package. Upon seeing the advertising, a consumer in the demographic group has a reason to believe the ingredients conform to authentic Mexican salsa and wants to try the food product. Then the strong taste and aroma of cilantro and lime flavored oil flavor drivers provides a flavor that meets the consumer's expectations, resulting in a sustainable food product.

While this invention has been particularly shown and described with reference to a preferred embodiment, it will be understood by those skilled in the art that various changes in form and detail may be made therein without departing from the spirit and scope of the invention.

1. A method for selecting an additive for a food product said method comprising the steps of:
(a) identifying a demographic group;
(b) identifying a plurality of flavor drivers familiar to said demographic group;
(c) identifying a desired product concept for said food product;
(d) identifying at least one flavor driver as supporting said product concept by consumer testing of the demographic group; and
(e) applying the at least one flavor driver identified in step (d) to said food product.

2. The method of claim 1 wherein said demographic group is defined by a statistical characteristic selected from the group consisting of age, race, sex, income, net worth, marital status, religion and educational attainment of one or more combinations thereof.

3. The method of claim 1 wherein said flavor drivers are identified by consulting chefs familiar with said demographic group.

4. The method of claim 1 wherein said desired product concept is visually represented by a concept board.

5. The method of claim 1 wherein step (d) is accomplished by a consumer test using a concept board, said consumer test comprising the steps of:
(1) smelling said food product;
(2) tasting said food product to solicit a response to the product;
(3) comparing said response to said product with a plurality of qualities shown on a concept board;
(4) rating said flavor driver to provide a match with said desired product concept.

6. The method of claim 5 wherein the rating of said food product at step 4 comprises rating the food product for an emotional response.

7. The method of claim 1 wherein said flavor drivers are applied at step (e) with a flavored oil.

8. The method of claim 1 wherein said food product comprises a snack food.

9. The method of claim 8 wherein said snack food comprises a starch based substrate.

10. The snack food of claim 9 wherein a starch from said starch-based substrate is derived from the cereal group consisting of amaranth, barley, buck wheat, corn, millet, oats, rice, rye, sorghum, and wheat or one or more combinations thereof.

11. The snack food of claim 9 wherein a starch from said starch-based substrate is derived from a legume group consisting of beans, peas, and lentils or one or more combinations thereof.

12. The snack food of claim 9 wherein a starch from said starch-based chip substrate is derived from the tubers group consisting of arrowroot and potatoes or one or more combinations thereof.

13. The method of claim 1 further comprising the step of:
f) displaying at least one image or phrase relating to said product concept for product marketing.

14. The method in claim 13 wherein said image further comprises an illustration or a description of at least one reason to believe ingredient.

15. A food product selected by the method of claim 1.
